(19) United States
(12) Patent Application Publication
(10) Pub. No.: US 2006/0086659 A1
(43) Pub. Date: Apr. 27, 2006

(54) Method for digestion of sludge in water purification

(75) Inventors: Estera Szwajcer Dey, Lund (SE); Olof Norrlow, Helsingborg (SE)

Correspondence Address: BIRCH STEWART KOLASCH & BIRCH, PO BOX 747, FALLS CHURCH, VA, 22040-0747, US

(73) Assignee: Kemira OYJ, Espoo (FI)

(21) Appl. No.: 10/526,041

(22) PCT Filed: Sep. 12, 2003
(86) PCT No.: PCT/SE03/01436

§ 371 Date: Sep. 26, 2005

(30) Foreign Application Priority Data
Sep. 13, 2002 (SE) 0202713-4

(51) Int. Cl. C02F 3/00

(52) U.S. Cl. 210/603

(57) ABSTRACT

The present invention relates to a method for digestion of sludge in water purification, which method comprises the steps: providing an enzyme mixture capable of digesting natural polymeric materials, adding the enzyme mixture to an aqueous sludge suspension, and thereafter, adding at least one species of fermenting bacteria to the suspension, thereby fermenting the resulting suspension.

### TECHNICAL FIELD OF THE INVENTION

The present invention relates to a method for digestion of sludge in water purification and to the use of said method in addition to or instead of conventional digestion used in water purification.

### BACKGROUND ART

The processing and disposal of wastewater treatment sludge are increasingly important topics of environmental, economical and technological concern. Recently, the waste volumes produced have increased dramatically as a result of increases in the organic loading of wastewater and environmental regulations that require a higher degree of wastewater treatment. After sewage treatment at wastewater plants there is still over 1 million ton sludge produced each year in Sweden. By tradition, this sludge has been spread out on fields as fertilizer, or it has been deposited or combusted. However, many problems have arisen. In 1999 Lantbrukarnas Riksförbund, the farmer's national union in Sweden, warned their members from using sludge as fertilizer as they suspected the sludge to contain hazardous substances. Disposal by landfilling is also becoming increasingly expensive. The growing and closing of landfills, public concerns over ground-water contamination and safety problems associated with methane production as a result of biological activity in landfills further expand the problem. Public concern over possible hazardous products through combustion processes and possible heavy metal contamination from the resulting ash is also problematic. Therefore a new waste tax was introduced in January 2002 to encourage researchers to find a better solution. By year 2005, the situation becomes even more critical as by then it will be completely illegal to deposit organic material as sludge. Therefore, the problem with the great amount of sludge mass is urgent today and the need for new treatment methods is immediate.

There are also other reasons why alternative methods should be tested. Sludge contains valuable resources as organic matter, energy and nutrients such as phosphorus and nitrogen. Due to the big increase in population, there will be a lack in phosphorus within the coming century, and phosphorus is a vital substance for living organisms. Therefore, sludge treatment that both decreases the sludge mass and is a source of products like phosphorus and biogas is desirable.

In general, the following types of wastewater treatment methods can be found:
1. Mechanical/physical methods, such as sedimentation, flotation, thickening, filtration, centrifugation and membrane technology (ultra filtration, reverse osmosis).
2. Physicochemical methods, such as evaporation, stripping, absorption, ion exchange, chemical precipitation, combustion, pyrolysis, gasification and adsorption.
3. Biological methods, such as aerobic treatment, anaerobic treatment, and other anoxic processes (denitrification, sulphate reduction).

Sludge separated after treatment is usually called raw sludge. The sludge has different names depending on where in the treatment process it is removed. Primary sludge has been separated after the mechanical step, secondary sludge after the biological step and tertiary sludge has been separated after the precipitation step.

Although it may be necessary to combine different methods to achieve the desired result, biological techniques clearly have the greatest potential for treating wastewater. Biological processes can be used to remove biodegradable organic compounds, nitrogen, phosphorus and sulphuric compounds, pathogenic organisms and various heavy metals. If efficient terminal electron acceptors such as sulfate, nitrate and oxidized forms of metals are not present in anoxic environments, methanogenesis occurs as the primary degradation pathway of organic substances.

Thus, the processing and disposal of wastewater treatment sludge are increasingly important topics of environmental, economical and technological concern. As previously stated above, it will be illegal in Sweden to deposit organic material as sludge by 2005. Therefore the problem with the great amount of sludge mass is very urgent today and the need for new treatment methods is of high priority.

### SUMMARY OF THE INVENTION

The present invention relates in one aspect to a method for digestion of sludge in water purification, wherein the method comprises the steps:

a) providing at least one enzyme mixture(s) capable of digesting natural polymeric materials;

b) adding the at least one enzyme mixture(s) to an aqueous sludge suspension; and thereafter,

c) optionally adding at least one species of fermenting bacteria to the suspension, thereby fermenting the resulting suspension obtained in step b).

The present invention relates in one aspect to a method for digestion of sludge in water purification, wherein the method comprises the steps:

a) providing an enzyme mixture capable of digesting natural polymeric materials;

b) adding the enzyme mixture to an aqueous sludge suspension; and thereafter,

c) adding at least one species of fermenting bacteria to the suspension, thereby fermenting the resulting suspension obtained in step b).

The invention in another aspect relates to the use of a method according to the invention, in addition to conventional digestion used in water purification.

The invention further relates to the use of a method according to the invention instead of conventional digestion used in water purification.

### BRIEF DESCRIPTION OF THE DRAWINGS

FIGS. 1A and 1B show the WS (wet solid weight) and the TS (dry solid weight), respectively, based on analyses corresponding to 20 ml sludge suspension. All data were collected during the enzyme optimisation experiment (experiment 2). The enzymes were added at day 0 and the effect of their action was studied during days 1-3. On day 3, Gluconobacter oxydans was added and at day 7 the mixed methanogenic bacteria culture was added. The samples were studied further.

FIG. 2 The wet solid weight mass reduction calculated from analyses of 20 ml volume of sludge suspension during experiment 1. The samples were made in duplicates. The enzymes were added at day 0 and their effect on sludge was studied at day 3. Mixed methanogenic bacteria culture was added on day 3. How the different conditions have been combined in the different trials can been seen in table 2. The samples were studied further.

FIG. (3)-(5). Data from analyses made during the optimisation of sludge mass reduction (experiment 3). The different figures represent respectively; FIG. (3a): Wet solid weight, FIG. (3b): Total dry solid weight, FIG. (4a): COD, FIG. (4b): Optical Density, FIG. (5a): NO₃, FIG. (5b): PO₄, WS and TS were analysed in 20 ml sludge volume. The enzymes were added at day 0 and the effect of their action was studied at day 2. On day 2, Bacillus macerans was added. The thermochemical treated sample in all figures is both treated thermochemically and with enzymes and bacteria. Explanation of the samples: (A) addition of vitamins and trace elements, (B) addition of supernatant obtained after sludge hydrolysis, (C) addition of surfactant FAE (fatty alcohol ethoxylate), (D) combination of (A)-(C).

FIG. 6 shows a TS (dry solid) measurement of sludge samples marked A, C, D and H (experiment 4). Sample A comprises enzyme with 0.025% of DC 1598. DC 1598 is a polydimethylsiloxane (PDMS) copolymer, the trade mark DC stands for Dow Corning. The distribution of the main components in this polymer are: PDMS (33%), ethylene oxide (44%), propylene oxide (23%). The block of ethylene oxide (44%) and propylene oxide (23%) in this copolymer has a non-ionic surfactant function. C comprises enzymes combined with 0.025% FAE (surfactant). D (reference) comprises no enzymes and no surfactant and H is thermochemically treated followed by addition of enzymes and bacteria but no surfactant. In all cases except the reference, enzymes were added at a ratio of 1:160. Shown in the figure are the results after 0, 1, 2, 4, 7, 8, 11 days corresponding to each of the bars in order from left to right.

### DESCRIPTION OF EMBODIMENTS OF THE INVENTION

In an embodiment of the invention the enzymes being provided in the enzyme mixture are chosen from, but not limited to, cellulases, amylases, lipases, pectinases, dextranases, proteases, pulpzymes and oxidases. Any enzyme being able to digest the sludge may of course be used in the enzyme mixture. A person skilled in the art may easily choose other variants of the enzymes. The choice of the enzymes used in the enzyme mixture is dependant upon the origin of the sludge suspension, i.e. domestic waste and/or industrial waste, the results being desired and on economy aspects. Further ingredients may be added to the enzyme mixture such as emulsifiers and suspending agents in order to facilitate the substrates to become more available to the bacteria being added afterwards.

In another embodiment of the invention the enzyme mixture comprises a surfactant, which preferably is non-ionic. In a further embodiment the surfactant is chosen from, but not limited to, natural and synthetic alcohol ethoxylates, FAE (fatty alcohol ethoxylate), pluronics, polydimethylsiloxane co-polymers and different Tweens such as Tween 20, Tween 40 and Tween 80. Tween is a trademark for a series of general purpose emulsifiers and surface active agents. They are polyoxyethylene derivatives of fatty acid partial esters of hexitol anhydrides. They are generally soluble or dispersible in water and differ widely in organic solubilities, The Condensed Chemical Dictionary, 6^{th} Ed., Copyright 1950, 1956, Reinhold Publishing Corporation, New York, formerly directed by Francis M. Turner, completely revised and enlarged by Arthur and Elizabeth Rose. Pluronics is a trademark for non-ionic surface active agents prepared by the addition of ethylene oxide to propylene glycols. They are available in liquid, paste, flake and powder form and all are 100% active agents, Condensed Chemical Dictionary, 6^{th} Ed., Copyright 1950, 1956, Reinhold Publishing Corporation, New York, formerly directed by Francis M. Turner, completely revised and enlarged by Arthur and Elizabeth Rose. The surfactant is present in the range of 0.0025-5 w/w % of the sludge suspension, preferably in the range of 0.005-2.0 w/w %. The surfactant changes the surface tension, which makes the substrates in the sludge more accessible for the bacteria. Any surfactant capable of making the substrates in the sludge more accessible for the bacteria may naturally be used and is within the scope of the present invention. All results obtained with surfactants speak for a wider use of this treatment.

In a yet further embodiment of the invention the dose of the enzyme mixture per sludge suspension is 0.2-0.001 enzyme mixture per 1% TS sludge, preferably 0.06-0.001 enzyme mixture per 1% TS sludge.

In an embodiment of the invention the fermenting bacteria are chosen from acidogenic bacteria, acetogenic bacteria, and methane producing bacteria. The acidogenic bacteria are capable of producing acids containing 1-6 carbons, such as formic acetic, propionic, butyric or lactic acid. One advantage of the invention is that as the amount of sludge is reduced at the same time a further product is obtained, e.g. methane in the case of methane producing bacteria. The resulting products may be separated, purified and further used in other applications. This is of course beneficial from an economical point of view. Thus, in addition to excellent digestion of the sludge, one obtains further products from the digestion which are of high value. These further products need not be only methane, but of course any product which is produced by the bacteria used.

In a preferred embodiment of the invention at least one species of the fermenting bacteria is methane producing bacteria. The methane producing bacteria could either be added to a conventional digester or they are already present in a digester if for example the process is a continuous process. Other bacteria may also be added in the digester or in another step of the continuous process. However, it is also possible that the process is a batchwise process. In a yet further embodiment the methane producing bacteria are chosen from the genera Methanosarcina and Methanosaeta, e.g. from the species Methanosarcina barkeri, Methanosarcina mazeii, Methanosarcina acetivorans, Methanosarcina soehngenii and mixtures thereof. Methanosaeta is the only species which stoichiometrically converts acetate to methane, while the others uses also H₂, CO₂, ethanol, formate, and other organic acids. In a further embodiment of the invention the fermenting bacteria are chosen from Gluconobacter oxydans, Acetobacter species, polymyxa, Bacillus coagulans, Lactobacillus, Acetogenium kivui, Lactobacillus buchneri, and Pseudomonas species. Further bacteria which may be used within the scope of the present invention are the genera Bacillus, e.g. the species Bacillus macerans, and the genera Clostridium, i.e. Clostridium thermoaceticus, Clostridium lentocellum, Clostridium formicoaceticum and Clostridicum thermocellum.

The natural polymeric materials which the microorganisms digest are, but not exclusively, proteins, polysaccharides, fats, waxes, mineral oils and polyphenols such as lignins. The natural polymeric material are digested to simple sugars, such as di- and monosaccharides, unsaturated and saturaded fatty acids having 4-25 carbon atoms, peptides and amino acids.

The nature of the bacteria used in the digestion plays a role when considering when to add the same to the sludge suspension. Some bacteria act faster on the substrates in the sludge suspension than others. The invention is not to be considered limited to when the different species of bacteria are added to the sludge suspension. The sludge reduction profile is studied day by day in the examples, see figures. In another example of the invention the enzyme mixtures are added to the sludge sample sequentially, eg a first enzyme mixture is added to the sludge sample at time 0 and a second enzyme mixture including proteases is added after approximately 15 min to 2 h. However, it is possible for the second addition of either enzyme mixture or bacteria to be within the range of approximately 15 min to approximately 10 days.

In an embodiment of the invention the temperature of the sludge suspension is in the range of 10-90° C., preferably in the range of 20-40° C. The temperature used depends of course on the enzymes and bacteria being used. A person skilled in the art realizes which temperature is appropriate for a certain kind of enzyme and bacteria.

In another embodiment of the invention the sludge suspension is subjected to agitation in the range from 0 to 180 rpm. It is also possible to subject the sludge suspension to agitation in the range mentioned above in intervals, i.e. the sludge suspension is agitated for 0-10 minutes and is thereafter left without agitation for some time and thereafter subjected to agitation again. This may be continued until desirable sludge reduction is obtained.

In a further embodiment of the invention the sludge is pre-concentrated, prior to the addition of enzymes and bacteria, by gravitation or enhanced sedimentation to the range 50-500 g sludge solids per 1 l sludge suspension, preferably to the range of 10-300 g sludge suspension per 1 l sludge suspension. Thereby, the enzymes and bacteria act more effectively on the substrates in the sludge suspension.

In a further embodiment the sludge suspension is subjected to a pre-treatment chosen from the group comprising of acid treatment, base treatment, sonication, grinding and heating prior to the method according to the present invention. The sludge suspension may be subjected to a hydrolysis, wherein the pH of the sludge mass suspension is adjusted by adding an acid, and the resulting suspension is exposed to a temperature from 20° C. to 190° C., preferably the pH of the sludge suspension is adjusted to between 2 and 4 with H₂SO₄. Any other acid, e.g. any organic or inorganic acid, may of course be used for lowering the pH. In one embodiment the resulting suspension is autoclaved at a temperature of 121° C. under 30 minutes. Further, the pH of the resulting suspension, after cooling, is increased with a base, preferably to pH 7 with NaOH or any other suitable base. Extremely good results are obtained when the sludge suspension is subjected to a thermochemical treatment prior to the addition of the enzyme mixture and the different species of bacteria. This combination resulted in the enhancement of anaerobic biodegradation of 55% in wet solid weight.

The method according to the invention may be used on any of the different kinds of sludge, i.e. primary, secondary and tertiary sludge, mentioned above.

The invention will be further described in the examples given below.

Material and Methods

“Enzyme Cocktail”

Five different enzymes were mixed to prepare an enzyme cocktail; Alcalase 2,4L FG, Lipolase 100L EX, Dextranase 50L, Celluclast 1,5L FG and Pulpzyme HC. All enzymes were supplied by the producer (Novozyme BioIndustrial A/S, Bagsvaerd, Denmark). A surfactant, FAE (fatty alcohol ethoxylate) (MB-Sveda, Malmö, Sweden), was also added to the solution, to facilitate the digestion of the substrates. A binding emulsifier such as xanthan gum has also been included. The final concentrations of the ingredients can be seen in table 1.

Alcalase 2,4L FG is a proteolytic enzyme designed to hydrolyze all kinds of proteins including haemoglobin. The declared activity is 2.4 AU/g (Anson units). Lipolase 100L EX is a lipase which hydrolyses fat by cleaving the ester bonds in the 1 and 3 positions of triglyceride molecules into more soluble materials, usually a mixture of mono- and di-glycerides, glycerol, and free fatty acids. Lipolase has a broad activity and promotes the hydrolysis of a wide range of fatty substances. The declared activity is 100 KLU/g (kilo Lipase Units). Dextranase 50L hydrolyzes 1,6-alpha-glucosidic linkages in dextran. The breakdown products are mainly isomaltose and isomaltotritose. It has a declared activity of 50 KDU/g (kilo Novo dextranase). Celluclast 1,5L FG catalyzes the breakdown of cellulose into glucose, cellobiose and higher glucose polymers. It has a declared activity of 700 EGU/g (endo-glucanase units). Pulpzyme HC catalyzes the hydrolysis of deacetylated xylan substrates. It contains endo-1,4-beta-D-xylanase activity (E.C: 3.2.1.8), and is virtually free of cellulase activity. It has a declared activity of 1000 AXU/g (xylanase units).

TABLE 1
The final concentrations in the enzyme cocktail

| | Final |
|---|---|
| Enzyme | Concentration (%) |
| Alcalase | 2 |
| Lipolase | 2 |
| Dextranase | 2 |
| Cellulast | 2 |
| Pulpzyme | 2 |
| FAE* | 0.1 |
| Xantan | 0.2 |
| Water | 91.5 |

*FAE = Fatty Alcohol Ethoxylate

Mixed Methanogenic Bacteria Culture

The culture used in this study was isolated from a methanogenic digester, obtained from Biological Waste Treatment, New Dehli, India. The culture composed of different methanogenic bacteria. The defined medium was prepared in 1 L batches and sterilised in an autoclave, 121° C. for 30 minutes. The medium contained per litre: Sodium acetate 1 g, NH₄Cl 1 g, yeast extract powder 0.25 g, KH₂PO₄ 0.1 g, K₂HPO₄ 0.2 g, MgCl₂*6H₂O 0.075 g, FeCl₃ 0.025 g (Biological Waste Treatment, T. R. Sreekrishnan). The bacterial strain was grown on agar plates and stored at 4° C. A loopful of bacteria from the plates was used to inoculate new agar plates, which were incubated (Termaks) for 48 h in 37° C. One bacteria colony was used for inoculation of the 500 ml Erlenmeyer flask, which contained 100 ml medium. The flasks were incubated on a rotary shaker (Gallenkamp) at 37° C. and 120 rpm, for 48 h. The flasks were flashed with nitrogen, for 15 seconds, to keep the anaerobic environment. Suspended cell density was determined on a spectrophoto-meter (Hitachi U-3200) at 600 nm. The flasks were kept in 4° C. until they were required. The cells were harvested by centrifugation (12000 g for 15 min, 4° C.). The wet cell mass was determined on a balance (Mettler AC 100) and before used, suspended in NaCl (0.9%).

Gluconbacter Oxydans

One of the bacteria strains used in this study was Gluconobacter oxydans (ATCC 621), which was obtained from American Type Culture Collection (ATCC), Manassas, Va., USA. The strain was maintained on a defined medium which was prepared in 1 L batches and sterilised in an autoclave, 121° C. for 30 minutes, and contained per litre: 10 g Glucose, 10 g yeast extract, 20 g Calcium carbonate and 20 g agar. The carbon source, glucose, was added separately after sterilisation. The bacterial strain was grown on agar slants and stored at 4° C. A loopful of bacteria from the slant was used to inoculate 500 ml Erlenmeyer flasks containing 100 ml medium each. The flasks were incubated on a rotary shaker (Termaks) at 30° C. and 120 rpm, until reaching the exponential phase (22 h). Suspended cell density was determined on a spectrophotometer (Hitachi U-3200), at 600 nm. The flasks were kept in 4° C. overnight. The cells were harvested by centrifugation (12000 g for 15 min, 4° C.). The wet cell mass was determined on a balance (Mettler AC 100) and before used, suspended in NaCl (0.9%).

Bacillus Macerans

Bacillus macerans, PCM 1399, used in this study was obtained from The Institute of Immunology and Experimental Therapy, Poland. The culture originates from the Pasteur Institute, Paris, France. The cells were grown on LB-medium (5 g yeast extract, 10 g peptone and 10 g NaCl) dissolved in 1 L water and sterilised at 121° C. for 30 minutes. The bacterial strain was grown and maintained on agar slop or slant and stored at 4° C. A loopful of bacteria from an agar slant was used to inoculate 500 ml Erlenmeyer flasks with 100 ml medium. The flasks were incubated on a rotary shaker at 30° C. and 120 rpm, for 17 h. The cell density was determined with a spectrophotometer (Hitachi U-3200), at 600 nm. The bacteria in the flasks were kept in 4° C. for two days. The cells were harvested by centrifugation (12000 g for 15 min, 4° C.). The wet cell mass was determined on a balance (Mettler AC 100) and diluted in NaCl (0.9%).

Analytical Procedure

Sludge samples were obtained from Källby wastewater treatment plant in Lund, Sweden. Sludge was sampled at three different occasions. Said plant treats both domestic waste and industrial waste. First the waste enters bar racks where for example paper is removed. Secondly sand is separated in a grit chamber. Before the sludge enters the biological step primary sedimentation takes place and such primary sludge was collected. In the laboratory, the primary sludge was left for sedimentation in 4° C. for 3 hours, and the wet solid weight was adjusted from 4.80 mg/ml to approximately 115 mg/ml. This was the starting sludge concentration before all experimental procedures.

The following analyses were carried out; the wet solid weight (WS) was determined by centrifuging a 20 ml volume of sludge (6700 g for 15 min). In order to determine the total dry solid weight (TS), the samples were dried at 105° C. for 24 h. To check the reliability of the methods used to determine WS and TS a standard deviation(s) for each method was evaluated. Six sludge samples that had undergone the same treatment were selected and WS and TS were measured. The standard deviation for WS and TS was 1.8 mg/ml sludge and 0.1 mg/ml sludge, respectively. This shows a good reliability. The selected supernatants were assayed for phosphorus, nitrogen, COD, acetic acid and pH. Phosphorus, nitrogen and COD was analysed with reagents and equipment supplied by Dr. Lange GmbH, Düsseldorf, Germany and accordingly to Standard Methods. The chemical oxygen demand (COD) is used as a measure of the oxygen equivalent of the organic matter content of a sample that is susceptible to oxidation by a strong chemical oxidant as K₂Cr₂O₇. The Cr³⁺ can then be analysed colorimetrically. The pH was measured roughly with a Universalindicator pH 0-14 (Merck, Darmstadt, Germany). The acetic acid determination was performed using an enzymatic bioanalyses outlined by R-Biopharm GmbH (Darmstadt, Germany). The bioanalyses is based on the principle that acetic acid is converted to acetyl-CoA in the presence of the enzyme acetyl-CoA synthetase, ATP and coenzyme A. The acetyl-CoA then reacts with oxaloacetate to citrate in the presence of citrate synthase. The oxaloacetate required for this reaction is formed in another reaction where AND is reduced to NADH. The acetic acid determination is based on the formation of NADH measured by the increase in light absorbance at 340 nm. The sludge supernatants were also analysed by measuring the Optical Density (OD) at 600 nm, to get a picture of the different turbidity in the water phase from treated and untreated sludge sample.

Experimental Procedures

Experiment 1

In this experiment four conditions were chosen and tested as to their impact on the sludge reduction. Four conditions were chosen: (A) sonication time at 28 kHz (Bandelin SONOREX RK 510S), where it was expected the sonication to release dissolved organic compounds and break up the cell walls and release intracellular material; (B) Dilution, to study whether the sludge thickness affects the sludge mass reduction. The dilution was made by adding sludge supernatant; (C) temperature, to study how the temperature affects microbial growth; (D) agitation, to improve the nutrient access for the microorganisms. The combinations of these different conditions were varied according to table 2.

TABLE 2
The combination of conditions.

| | low- | High | | | | | | | | |
|---|---|---|---|---|---|---|---|---|---|---|
| Condition | (−) | (+) | 1 | 2 | 3 | 4 | 5 | 6 | 7 | 8 |
| A | 10 min | 30 min | − | + | − | + | − | + | − | + |
| B | 5x | 0x | − | − | + | + | − | − | + | + |
| C | 20° C. | 37° C. | − | − | − | − | + | + | + | + |
| D | 0.0 rpm | 180 rpm | − | + | + | − | + | − | − | + |

Beside the samples involved in the experiment, two hydrolysed samples were studied: (E) Thermochemical hydrolysis; (F) only thermal hydrolysis. All samples were made in duplicates.

All samples contained the same amount of sludge at the beginning. A 400-ml volume of sludge was placed in 500 ml Erlenmeyer flasks. One part of the enzyme cocktail (see table 1) was added to 150 parts of sludge, in all samples. For sample marked (A), (E), and (F) the addition took place after treatment since otherwise the enzymes would be destroyed. The isolated mixed methanogenic bacteria culture was added to all samples at three different occasions during the experiment, day 3, 7, and 10 counted from the start of the experiment. The bacteria concentration added was always the same: 0.14 g bacteria/sample. Acetate was also added to all samples at day 10 so the final acetate theoretical concentration was 0.1%. During the experiment the samples that requested agitation were placed in rotary shakers (Termaks), at 20° C. respectively 37° C. Every time samples for analyses were taken out, the samples were flushed with nitrogen for 30 seconds to keep the anaerobic environment. Before adding new bacteria samples were withdrawn for analysing WS and TS; day 3, 7 and 10. The same analyses were made day 12 before terminating the experiment.

The effect of sonication, temperature, agitation and dilution on sludge disintegration was studied in order to find out the preferential treatment conditions.

Sonication

The sonication has little effect on the WS mass reduction. The break-up of cell walls in a sludge sample during sonication differs between sludge sources due to the different number of solids and different density of the liquid.

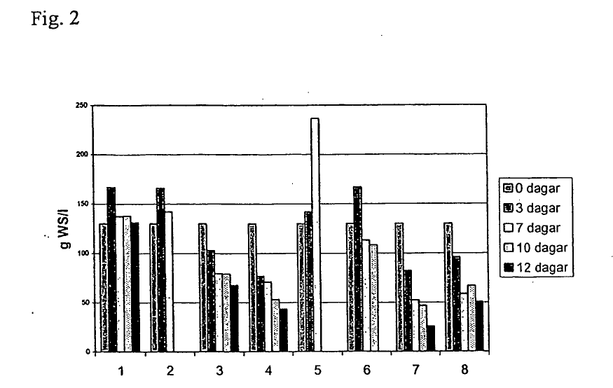

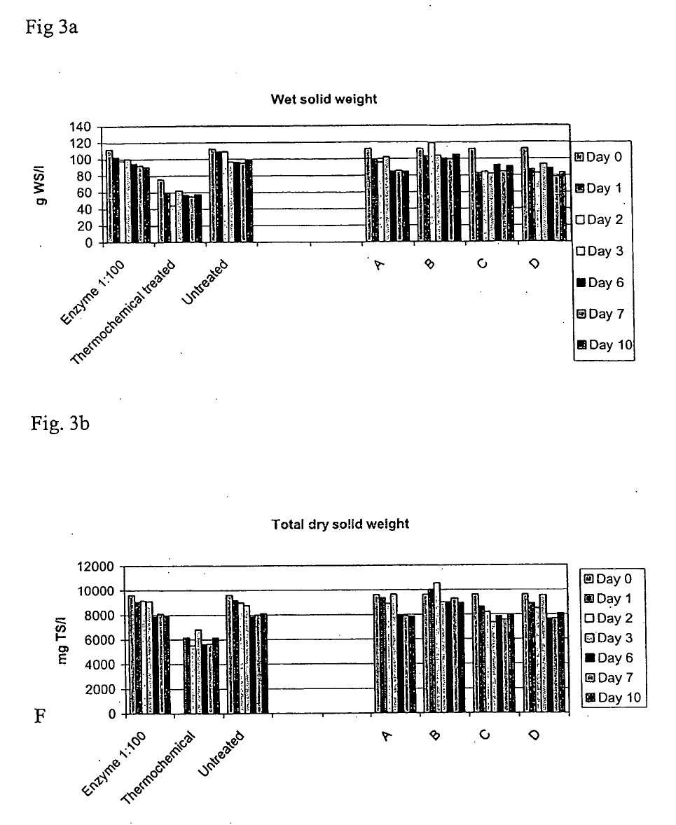

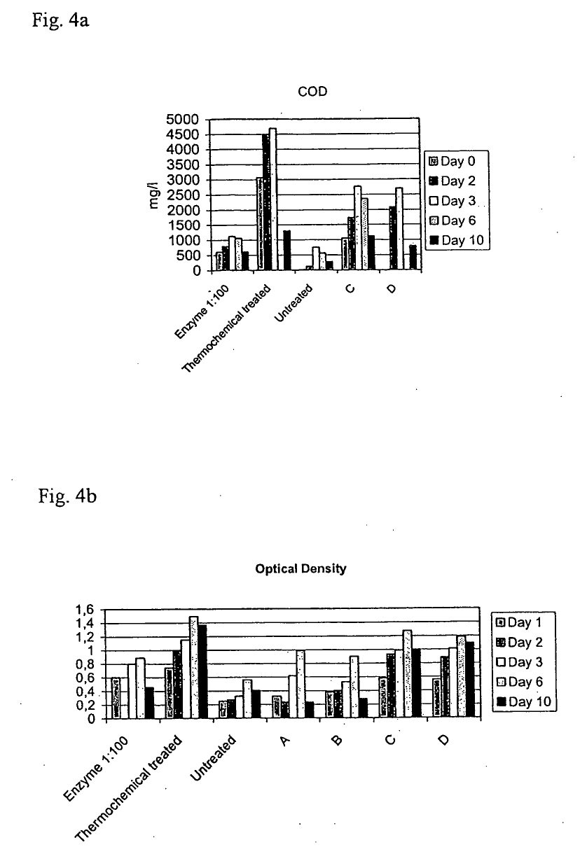

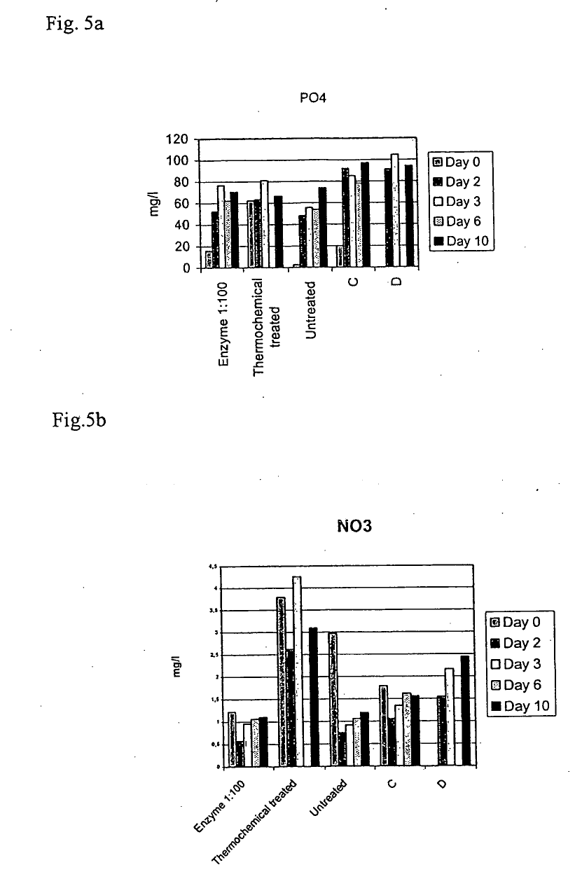

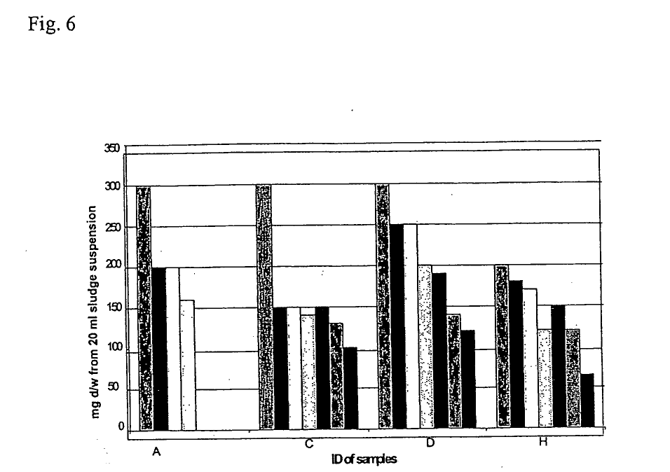

When comparing samples treated with short sonication time (sample 1, 3, 5 and 7) and samples treated with longer sonication time (sample 2, 4, 6 and 8), one cannot find a pattern that supports the arguments for using sonication (FIG. 2, day 1-3). The best known sonication treatment occurs at low frequencies and long sonication time. Since the only ultrasonication equipment available for this investigation had a standard frequency of 28 kHz this was the only frequency tested. For future experiments a higher frequency should be considered, to intensify the mechanical forces that break up cell walls. It is also suggested to use a longer sonication time, 60-150 minutes have been studied which showed good disintegration results.

Temperature

The temperatures 20 and 37 were used to determine the effect of temperature on the degradation process. However, temperatures in the interval 20-50° C. will be considered in the future. As for the sonication treatment one cannot find a clear pattern for the temperature treatment (FIG. 2, day 1-3). In the subsequent experiments the temperature was chosen from the added microorganism's optimal activity temperature.

Agitation

Agitation is the second most important condition in this experiment and therefore has a large impact on the WS mass reduction. Increasing the agitation from 0 rpm to 180 rpm does not lead to a positive effect on the mass reduction. Since a decrease in WS mass is desirable, no agitation is more preferably compared to agitation at 180 rpm. This is the reason why no agitation was chosen in the enzyme optimisation experiment. Still, this result was questioned since, logically, the microorganisms would digest the sludge better during agitation, as the access to the nutrients and substrates increases. In the samples which were not agitated mould was observed at same time as the mass increased. These two results, low WS mass reduction and mould, made us reconsider agitation in the next experiment. In the sludge mass reduction experiment agitation of 100 rpm was used instead of no agitation. COD of the supernatant from sludge treated with a more diluted enzyme ratio but agitated show a better sludge mass reduction (36% at day 6), than the non-agitated with double ratio of enzymes. Agitation can be carried out in different ways, which leads to a variation in the WS results.

Dilution

The dilution is the outstanding most important factor and has the greatest effect on the WS mass reduction. Decreasing the dilution from 5 times to no dilution at all leads to an increase of the mass reduction. This means that no dilution is preferable. This can also be seen easily in FIG. 2 were the samples 3, 4, 7, and 8 represent the biggest WS mass reduction. None of these samples are diluted. Hence, the samples in the following experiments were not diluted.

Thermochemical Hydrolysis

A thermochemical treatment includes adjusting the pH in the sludge to 2 by adding 1M H₂SO₄. The samples were then autoclaved at a temperature of 121° C. for 30 minutes. After cooling the pH was increased to 7, by adding 1M NaOH, to make it possible for the added enzymes and microorganisms to operate. A hydrolysis releases organics in the sludge, to make them more accessible for the microorganisms.

Enzyme Optimisation

Experiment 2

A 400 ml volume of sludge was placed in 13 Erlenmeyer flasks. Two samples were treated with thermochemical hydrolysis, (A) and (B). To give a better understanding of the enzymatic effect 0.05% Biocide Metatin K 520 S (Acima, Buchs, Germany) was added to two samples, (C) and (D). Biocide, depending on the concentration, is inhibiting to all the microorganisms in the sludge. The microbial degradation of the sludge will decrease.

The enzymatic cocktail (see table 1) was added to the untreated samples, in different amounts, to create a dilution series;. 1:25 (1 ml enzyme cocktail in 25 ml sludge sample) 1:50, 1:100, 1:200, 1:500, 1:1000, 1:2000. A concentration of 1:100 enzymes was added to one of the hydrolysed samples, sample (A) and the concentration of 1:25 to the biocide samples, (C) and (D). The cocktail was added only once to all the samples except to the sample with the lowest concentration, 1:2000, which received an enzyme dose of 1:2000, two times with an interval of 24 hours. This procedure was done to examine if the degradation was improved when enzymes were added once, in a bigger portion, or several times, in smaller portions. Two samples were kept untreated, sample (E) and (F), without enzyme addition, as references. Determination of WS and TS was made immediately after enzyme addition. To keep the anaerobic environment, the samples were flashed with nitrogen for 30 seconds every time the flasks were opened to take out sludge for analyses. Each Erlenmeyer flask was closed with a steristopper with a water lock, so that gases produced can come out but nothing is allowed to get in. The samples were incubated in an incubator (Termaks). at 30° C., as this is the optimal temperature for Gluconobacter oxydans. The samples were withdrawn at regular intervals to determine the mass reduction etc.

0.25 g/sample of Gluconobacter oxydans wet cells solution was added 3 days after the start of the experiment. When the bacteria were harvested the activity was equivalent to an OD of 1.7. The samples were flashed with oxygen, every time analyses were made, as Gluconobacter oxydans is an aerobic bacteria. The bacteria produce acetic acid from ethanol, therefore 4 ml EtOH (1%) was added to 1:100, day 3 and 6, to confirm the activity.

100 ml from the supernatant in sample 1:500 was removed, and replaced by distilled water to see whether or not the sample contained toxic compounds, which would affect the microorganisms negatively. The biocide samples were removed from the experiment after day 3.

0.10 g bacteria/sample of the mixed methanogenic bacteria culture was added 7 days after the start of the experiment. The bacteria were harvested in the exponential phase. As the methanogenic bacteria produce methane from acetic acid, 7.5 ml Sodium acetate (20%) was added to 1:1000, day 7, to confirm the activity. The samples were flashed with nitrogen, every time analyses were made, as the methanogenic bacteria are anaerobic. The experiment was ended after 14 days.

WS, TS was measured day 1, 3, 6, 7, 8 and 14. COD was made on a few selected samples, as COD is a relatively expensive method.

Optimisation of Sludge Mass Reduction

Experiment 3

A 400-ml volume of sludge was placed in 500 ml Erlenmeyer flasks. The experiment procedure was studied using sludge samples that were treated under different conditions; (A) addition of vitamins and trace elements according to a Methanosarcina mazeii medium recipe 318 (see table 3 below) to a concentration of 10 ml/l, to improve the nutrient environment for the methanogenic bacteria in the sludge; (B) addition of 100 ml supernatant obtained after sludge hydrolysis; (C) addition of 1 ml 10% surfactant FAE, (D) combination of (A)-(C); (E) sludge samples without further treatment; and (F) sludge after thermochemical hydrolysis. An enzyme concentration of 1:100 was added to each sludge sample. All samples were made in duplicates. Two samples containing the same amount of sludge though without enzyme treatment was also studied. Determination of WS, TS, COD, Nitrate, Phosphate, pH and Acetate was made immediately after pre-treatment (A)-(F). The flasks were then incubated in a rotary shaker (Termaks) at 30° C. and 140 rpm. The samples were withdrawn at regular intervals for analyses.

When the experiment had carried on for two days 0.3 g of Bacillus macerans PCM 1399 was added to all sludge samples except one of the samples without enzyme treatment. When the bacteria were harvested the activity was equivalent to an OD of 5.2. Since Bacillus macerans, when switched to fermentation, has to be kept in an anaerobic environment the samples were kept in excicator with AnaeroGen bags and oxygen indicator (Oxoid Limited, Hampshire, England) to control the anaerobic environment by converting oxygen to carbon dioxide. The active ingredient in the AnaeroGen is ascorbic acid. The sludge samples placed in the excicator were incubated at 30° C. and under slow rotation of 100 rpm.

Six days after the experiment had started 2 g/l acetate was added to stimulate the methanogenic bacteria in the sludge.

TABLE 3
Nutrients and trace elements in the medium for
methanogenic bacteria.

| Trace elements | (g/l) | Vitamin Solution | (mg/l) |
|---|---|---|---|
| Nitrilotriacetic acid | 12.80 | Biotin | 2.00 |
| (NTA) | | | |
| FeCl₃ × 6 H₂O | 1.35 | Folic acid | 2.00 |
| MnCl₂ × 4 H₂O | 0.10 | Pyridoxine-HCl | 10.00 |
| CoCl₂ × 6 H₂O | 0.024 | Thiamine-HCl × 2 H₂O | 5.00 |
| CaCl₂ × 2 H₂O | 0.10 | Riboflavin | 5.00 |
| ZnCl₂ | 0.10 | Nicotinic acid | 5.00 |
| CuCl₂ × 2 H₂O | 0.025 | D-Ca-pantothenate | 5.00 |
| H₃BO₃ | 0.01 | Vitamin B₁₂ | 0.10 |
| Na₂MoO₄ × 2 H₂O | 0.024 | p-Aminobenzoic acid | 5.00 |
| NaCl | 1.00 | Lipoic acid | 5.00 |
| NiCl₂ × 6 H₂O | 0.12 | | |
| Na₂SeO₃ × 5 H₂O | 0.026 | | |

Results
Effect of Enzyme Addition

The intention of enzyme addition to sludge is to improve the accessibility of organics to the microorganisms, both the natural existing microorganisms in the sludge and the added microorganisms. The commercial enzymes were tested before added to the sludge samples, according to standard procedure for actual activity.

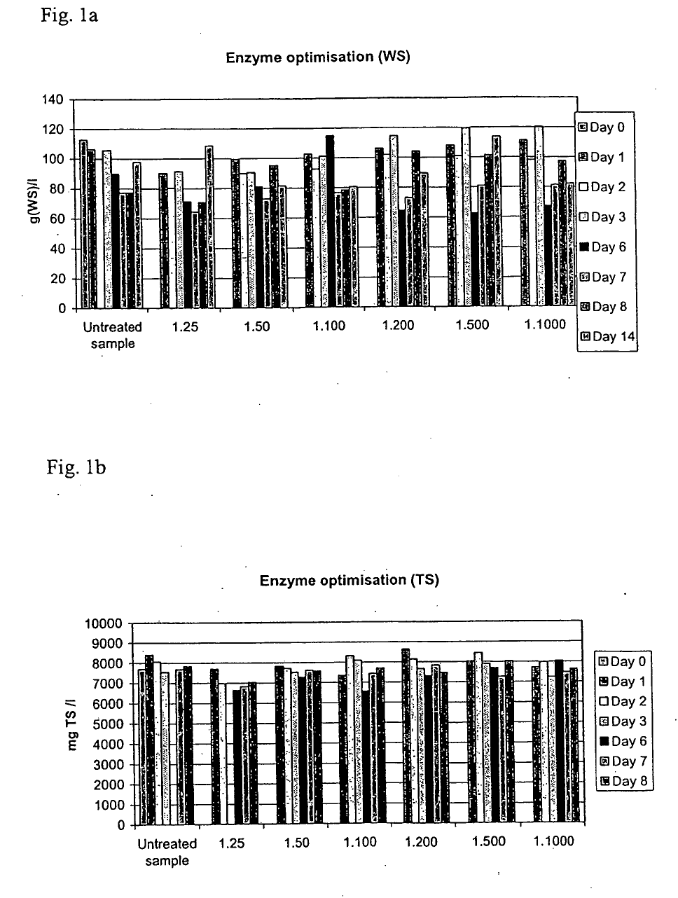

The WS (wet solid weight) and the TS (total dry solid weight) mass reduction in the enzyme optimisation experiment are shown in FIGS. (1a) and (1b), day 1-3. FIG. (1a) shows that the more enzymes added the greater mass reduction. Thus the best result is shown in sample 1:25 where 15% of the mass is reduced only after 1 day of treatment and the reduction is even greater after 2 days, 20%, compared to the untreated sample. This pattern is almost the same for TS in the enzyme optimisation experiment, where a mass reduction of 9% after 1 day and 13.5% after 2 days was observed (FIG. 1b). There is still an improved WS mass reduction in sample 1:100 compared to the untreated sample; 3.5% after 1 day respectively 7.5% after 2 days. The TS data for the same sample shows a mass reduction for day 1 of 13% and a mass increase for day 2 and 3. Lower enzyme concentration then 1:100-1:150 does not pay off, the WS reduction for these samples, 1:200-1:2000, is scarce or none. Sample 1:200 follows the same pattern as the untreated sample. This basic data is the reason why the enzyme concentration 1:100 was chosen throughout the subsequent experiments. The sample with 1:100 enzyme concentrations that was studied during the mass reduction experiment showed the same WS values as the enzyme optimisation experiment.

In FIG. 1b there is a missing value for 1:25 at day 3 due to a broken Erlenmeyer flask containing the sludge sample.

The enzyme dilution series was also evaluated by COD analyses on the sludge supernatant. Enzyme addition should increase the COD value since the enzymes were releasing soluble organics. The supernatant were each day more cloudy. One reason for this was that the samples got richer in dissolved matter and that the bacteria started to multiply. Microscopic examination showed that the supernatant has a lot of bacteria and in some cases also protozoa. The COD value of the sludge picked from the sewage plant was 16.4 mg/l. After 3 days the COD value had increased 10 times to 171.3 mg/l, which is the result of the enzymes produced by the microorganisms present in the sludge. The sludge sample treated with enzymes with the ratio 1:25 on day 1 has a COD of 2940 mg/l. The significant higher COD value is the evidence that some soluble organic matter has been dissolved into the water phase by the externally added enzymes. The COD analyse shows that lower enzyme concentration result in lower COD values.

In a new experiment, the optimisation of sludge mass reduction experiment, the starting sludge had a COD value of 20.7 mg/ml. Sludge samples treated with an enzyme ratio 1:100 showed the same WS mass reduction day 1 as sample 1:100 from the enzyme optimisation experiment, 3.5% reduction.

Effect of Chemical Treatment

The effect of the surfactant and nutrients added with the enzymes into some sludge samples can be seen in FIGS. 3-5, which shows data from analyses made during the optimisation of sludge mass reduction experiment.

Surfactant

Sample C in FIGS. (3)-(5) represents a sludge sample treated both with enzymes and the surfactant FAE at final concentration of 0.025%. The thermochemical hydrolysed samples and the surfactant treated sludge in combination with enzyme addition showed the best mass reduction results in this studied batch of sludges. A comparison between the enzymatically treated sample (1:100) and the sample treated with both enzymes and surfactant (C) showed an improved WS mass reduction for sample C of approximately 20% and 15%, day 1 and 2. A larger WS mass difference was noticed between the untreated sample and the sample treated with enzymes combined with FAE. The mass reduction was approximately 24%, at day 1 and 2. The COD and OD data correlate with the data of the mass reduction. Untreated sludge with an original COD of 20.7 mg/l showed an increase in COD, after 2 days, to 131. COD values, day 2, from sludge treated with enzymes combined with surfactant, increased from 1050 to 1740, whereas if only treated with enzyme the COD increased from 610 to 790 mg/l. The OD values are stable in the untreated sample, increase slightly in the treated sample and increase dramatically in the sample treated with surfactants.

Sample D represents a combination of different treatment methods; addition of nutrients, surfactants and supernatant from the thermochemically treated sludge. This sample has similar WS values, at least the first days, compared to the sample treated with surfactant. The explanation could be that the surfactant treatment is more effective than addition of nutrients and addition of supernatant from thermochemically treated sludge.

FIGS. 5a and 5b show a slight increase of both phosphate and nitrate in sample C and D, compared to both treated and untreated sample, which is difficult to find an appropriate explanation for.

Effect of Thermochemical Treatment

To evaluate the effects of the thermochemical pretreatment, changes on the soluble COD of the samples were utilised as an indicator of enhanced anaerobic biodegradability. Other analyses were also made. FIGS. 3-5 present all experimental results obtained with hydrolysed sewage sludge when the experiment to optimise the mass reduction was performed. At day 0 no enzymes have been added, the enzymes effect can be seen day 2 and day 3. The effect of Bacillus macerans can be seen at day 6.

It is obvious that a thermochemically hydrolysed sludge sample shows a 1000-fold more COD than the untreated sample (FIG. 4a). This shows the efficiency of thermochemical hydrolysation. When a thermochemical hydrolysed sample was further digested by addition of enzymes the COD increases approximately 50%, during 2 days (day 0-2). Enzyme treatment alone does not cause such a remarkable COD release as the combined treatment. However comparing the sludge treated with enzymes and the untreated reference at day 3, 50% difference in COD was observed between these sludge supernatants.

The hydrolysed sludge supernatants were very cloudy compared to untreated supernatants. The optical density value (OD) in FIG. 4b supports this as higher COD value corresponds to higher OD. The sample treated both thermochemically and enzymatically has day 2 an OD of 1.0 and the untreated sample has at the same time an OD of 0.27. The OD data and the COD data follow throughout all samples the same pattern (FIGS. 4a and 4b). The thermochemical and enzyme treated sludge releases 20% less PO₄ than the enzyme combined with FAE treated sample whereas the NO₃ is 2.5 times higher in the thermochemical and enzyme treated sample (FIGS. 5a and 5b).

When a sample was thermochemically treated the WS mass decreased with 32% (FIG. 3a). Added enzymes are reducing the WS mass further with 26% after 2 days. So in total the mass reduction is approximately 60% of the original sludge after 3 days. The untreated samples also slowly digested due to the action of the internally produced enzymes. A comparison between the both thermochemically and enzymatically treated sample and firstly the untreated sample and secondly the enzymatically treated sample at day 2 showed an improved reduction of 60% for WS and 40% for TS (see FIG. 3b). Thus no mass reduction was noticed in the enzymatically treated sample which is strange since in all other experiments mass reduction due to enzyme activity has been at the least 10% or more. This could be explained by differences in the sludge structure which can result in higher WS than expected.

Effect of Microorganisms

Three microorganisms were used in this project but for different purposes; mixed methanogenic bacteria culture, Gluconobacter oxydans ATCC 621 and Bacillus macerans PCM 1399. A fourth microorganism, Methanosarcina mazei, was planned to be used as a biogas producing bacteria. The bacteria, (34) is a common bacteria in sludge and used for its ability to oxidize acetic acid to methane.

Mixed Methanogenic Bacteria Culture

In the first experiment, the effect of the added methanogenic bacteria culture could be analysed at day 7 and forward. In all samples the WS mass decreased, with the biggest reduction values at day 1. This day a very wide WS reduction interval was seen, in sample 4 the WS mass reduction was 8% whereas in sample 8 it was 40%. Since fine WS mass reduction values for the culture were obtained the culture was again used in the enzyme optimisation experiment, where first Gluconobacter oxydans ATCC 621 was added and secondly the mixed methanogenic bacteria culture.

Gluconobacter oxydans was used in one experiment, the enzyme optimisation experiment. The bacteria have the ability to convert ethanol, produced from acetogenesis, and glucose to acetic acid which was the sole interest in the bacteria in the experiment. Ethanol in sludge can also derive from E. coli since as much as 50% of the products formed from E. coli can be EtOH. The effect of Gluconobacter oxydans ATCC 621 can be observed in FIG. 1a day 6 and day 7. The untreated sample has a WS mass reduction of 15% between day 3 and day 6. For day 6 all samples, but the sample with enzyme concentration 1:100, had a reduction of the WS and TS of approximately the same value as for the untreated. The sludge masses continue to diminish day 7 except for samples with low enzyme concentration. This indicates that the more soluble organics degraded by enzymes the easier biodegradability takes place. When EtOH was added to sample 1:100 no decrease in mass reduction occurred.

Gluconobacter oxydans ATCC 621 converts 0.1% glucose to acetate and 1% EtOH to acetate under aerobic conditions. If too little oxygen is supplied a lot of acetaldehyd accumulate which is toxic for the cells. The samples were flushed with oxygen each time the samples were withdrawn for analyses. There was no possibility to flush the samples continuously with oxygen and this might have affected the bacteria negatively.

Bacillus macerans PCM 1399 was used for its ability to oxidise sugars under anaerobic conditions to acetic acid. The bacteria was added day 2 in the last experiment, when an optimisation of sludge mass reduction took place. The bacteria were added day 2 instead of day 3. All data for the bacteria can be seen in FIGS. 3-5, day 3-10. For both WS and TS masses no remarkable change occurs after addition of bacteria. Almost all samples follow the same pattern as the untreated sample, that is a slight decrease of approximately 10% in mass from day 2 to day 3.

To control the sludge biodegradability the COD values were analysed. The COD reduction between day 3 and day 10 (see FIG. 4a) was 50%, 72%, 63%, 60% and 70% for sample: enzyme 1:100, thermochemically treated, untreated, C and D respectively. COD was also analysed at day 13 which is not shown in the figure. COD continued to decrease which shows that biodegradability is a very slow process, maybe longer experimental time would have shown a further decrease.

None of the sludge samples had acetate at the starting point. The acetate production increases dramatically on day 3. This shows that great activity was found in acetate producing bacteria. In the thermochemical hydrolysed sample all natural existing microorganisms are destroyed, therefore the only existing acetate producing bacteria is the added Bacillus macerans PCM 1399. The high amount of acetate on day 3 must therefore be a consequence of the added bacteria. One of the possibilities for acetate is to be oxidised to methane by methanogenic bacteria. However, other bacteria less sensitive to oxygen are present in the sludge and are competing for acetate. Some of them are glycogen accumulating and/or phosphate accumulating bacteria. As seen in all the samples, even the untreated sample, the acetate content decrease, which confirms that there are natural existing methanogenesis bacteria. Why this happens in the thermochemical treated sample is unclear since no organism except for Bacillus macerans PCM 1399 should be alive.

The COD:P:N ratio, 400:6.7:1, was checked and not once was the amount of sufficient phosphorus or nitrogen too low. So the activity and growth of all living organisms is not limited by these factors.

The highest amount of PO₄ has been observed in the enzymatically and FAE treated sample. The thermo-chemically treated sludge with enzymes contains the highest amount of NO₃.

Experiment 4

Sludge was obtained from Kalby waste water treatment plant, Lund, Sweden. TS=total solid dry mass was determined at 105° C., according to previously mentioned procedure.

Sludge samples were adjusted to 150 g/l of solid matter density. The starting volume of the sludge was 400 ml. The incubation was carried out in a water bath set to 37° C., under very slow agitation. Visually, almost the whole water phase was separated from the solid sludge.

The sludge was distributed into 4 Erlenmeyer flasks with a suction exit. At the top of each flask a tight rubber cork with coiled plastic tube filled with water was inserted. Through the suction exit a plastic tube was inserted with one end immersed in the sludge and the other end to the exit of the suction flask closed by a tight lock. For sampling, the sludge was mixed and a 50 ml syringe was inserted into the plastic tube to obtain ca 30 ml sludge suspension which was added to 50 ml labelled Falcon tubes. 20 ml of suspension was used for TS determination.

In these trials Bacillus macerans (DSM 24) was used. The strain was grown between 24-48 h in the LB defined media at 37° C. The cells were harvested by centrifugation at 7800 g for 10 minutes. The cells were weighted and suspended in small amount of water (40 mg/ml). 400 mg of wet cells was added to 400 ml sludge.

On day 0 enzyme cocktail, see table 1, was added to all of the samples A, C, and H. Simultaneously polydimethylsiloxane copolymer DC1598 or fatty alcohol ethoxylate (FAE), respectively, was added to samples A and C. Bacillus macerans DSM 24 was added to all the samples A, C, D, and H on day 2.

After 4 days of incubation (from day 0) the sludge masses have been reduced in sample C, D, and H with 160, 100, and 175 mg, respectively. After day 1 the difference between samples C and D is 100 mg. From FIG. 6 it is clear that the best results are obtained when firstly enzyme cocktail and surfactant are added, thereafter the bacteria are added. In sample H, the sludge reduction is less, only when B. macerans (DSM 24) is added on day 4 the reduction proceeds.

On day 4 water is removed and new water and Bacillus macerans is added to samples C, D, and H. Nutrition is also added to sample H on day 10 in the form of glucose.

The case may also be that some of the external enzymes are overlapping with the excreted enzymes from B. macerans (DSM 24).

On day 7, the solid sludge is separated from the supernatant and the supernatant is discarded. The remaining solid sludge was transferred back to the same bottles and suspended in 280 ml of fresh water with fresh B. macerans (DSM 24). The incubation conditions were continued as above. The sludge reduction proceeds.

Addition of easy digestible carbon source dramatically improves the digestion of sludge in sample H. More systematic studies on this improvement will be made.

Experiment 5

It has also been shown in connection with the present invention that the vitality of the already existing organisms, eg pathogens and Microthrix parvicella, in the sludge suspension is reduced considerably when treating the sludge suspension with two separate enzyme mixtures.

ATP (adenonsine triphosphate) has been considered a living biomass indicator for wastewater and activated sludge. The high energy compound is rapidly destroyed upon death of organisms and this has been suggested as a means of monitoring the biomass vitality in activated sludge (Arretxe, M. et al, The effect of toxic discharges on ATP content in activated sludge, Toxicology and Water Quality (1997), 12(1), 23-29). ATP based methods has been used for identification of bacteria in food and water samples or even as an indicator for protozoa in sludge such as Cryptosporidium parvum oocysts.

The living biomass of sludge is composed of different microorganism including, pathogens and sometimes foam producers such as, Microthrix parvicella. Pathogens, are one of the hindrances why sludge can not be spread over landfills. The foam producers are negative factors effecting the water plant and also effecting the work in the digesters.

In the present example, samples with a different TS (%) of sludge were treated firstly with an enzyme mixture A and thereafter with an enzyme mixture B. The enzyme mixture A is composed of the Enzyme cocktail mentioned in Table 1 with the exception of Alcalase. Enzyme mixture B is composed of Alcalase, which is a protease enzyme. The enzyme mixture A is added at 0 h directly after the ATP measurement of the sludge suspension without any added enzyme mixtures. The second measurement of ATP is made after 2 h and before the addition of the second enzyme mixture B. Thereafter a third ATP measurement is made after 4 h and in one case after 8 h.

The ATP content was determinated in accordance with method of Arretxe et al above. From Table 4 it is shown very clearly that the vitality of the existing bacteria present in the sludge is reduced almost completely during enzymatic treatment. This is advantageous not only in view of the eliminated pathogens but also in view of the fact that the bacteria that will be added in the next step will grow faster due to lack of competetion.

TABLE 4
Vitality profile during enzymatic treatment ATP, (mg/L)

| | 0 h, | 2 h, | 4 h, | 8 h, |
|---|---|---|---|---|
| TS, (%) | Starting | Mixture A | Mixture B | mixture B |
| 1 | 1, 2 | Tr.a | Not found | — |
| 2 | 3, 4 | Tr.a | Not found | — |
| 4 | 5, 4 | Not found | Not found | — |
| Ref. 4 | 5, 4 | 5, 4 | 5, 4 | |
| 4-2xE* | 5, 4 | Not found | Not found | — |
| 4-2xh** | 5, 4 | Not found | — | Not found |

Tr.a means trace amounts of ATP
Ref. 4 is a reference sample and not treated with any enzyme mixtures
4-2xE* is a sludge sample with a TS(%) content of 4 with a double dose of enzyme
4-2xE** is a sludge sample with a TS(%) content of 4 and measuring the ATP content after 8 h instead of after 4 h.

Discussion

This study describes the use of a recent developed enzyme solution in combination with different treatment methods on sludge with the goal to reduce the sludge mass. Clearly, treated municipal sewage sludge contains considerable levels of solids, being fast and slow hydrolysable, that can be further degraded to reduce the waste volume, and therefore reduce disposal costs and produce additional energy (methane).

The added enzymes degrade the organics in the sludge. The enzymes do not only reduce the sludge mass, but also induce the growth of the microorganisms. Organics are degraded to greater extent the more enzymes being added. To optimise the utilisation of enzymes, when considering degradation efficiency and costs, no lower concentration than the enzyme-sludge ratio 1:100-1:150 is suggested. The sludge mass reduction obtained during our experiments showed that commercial enzymes were less effective than thermochemical hydrolysis in combination with enzymatic treatment. Thermochemical treatment was chosen since earlier studies made during the Krepo project at Kemira show that this is an effective way to reduce sludge mass. However, even more effective were thermochemical treatments in combination with enzyme treatment. This combination in all three sewage sludge experiments resulted in the enhancement of anaerobic biodegradation of 55% in wet solid weight. The level of soluble COD increased significantly after both treatments were made. When sludge is thermochemically treated all living organisms are destroyed and hence new active microorganisms are needed to be added to ensure that the anaerobic digestion; e.g. hydrolysis, acidogenesis, acetogenesis and methanogenesis can be carried out. The added microorganisms can also direct the biosynthesis of wanted products. The microorganisms tested in the present application were a mixed methanogenic bacteria culture, Gluconobacter oxydans and Bacillus macerans.

Another promising WS reduction result was obtained when sludge was treated with enzymes combined with the surfactant FAE (Fatty alcohol ethoxylate). A comparison between the sample treated only with enzymes and the sample treated both with enzymes and surfactant showed an improved WS mass reduction. The surfactant changes the surface tension, which makes the substrates more accessible for the microorganism. The surfactant also participates partially in removal and accessibility to some exopolysaccharides (EPS) which can be at different amount depending on the sludge batch. All results obtained with surfactants speak for a broader use of this treatment, perhaps should a higher amount of surfactant in the enzyme cocktail be considered.

Bacillus macerans showed good acetate production especially in the thermochemical and enzymatical treated sludge samples. This is evidence for a good activity of the bacteria, especially the clean strain DSM 27. Maybe, if a well-known acetate depending methanogenic bacteria as Methanosarcina mazeii had been co-inoculated with Methanosaeta and been added the sludge mass reduction would have been more notable. After using Bacillus macerans (PCM 1399) in the experiment the strain was examined in a microscope. This showed that the strain was infected, the majority of the bacteria were Bacillus macerans but other bacteria were also found.

Anaerobic treatment offers an enormous potential for the removal of organic materials from wastewaters. The results from this investigation, especially from the experiment with both thermochemical treatment, enzymatic addition and bacteria addition, show that anaerobic digestion can be accelerated and thus is an efficient way of reducing the sludge quantities from wastewater treatment plants.

1. A method for digestion of sludge in water purification, characterised by the steps:
a) providing at least one enzyme mixture capable of digesting natural polymeric materials;
b) adding the at least one enzyme mixture sequentially to an aqueous sludge suspension; and thereafter,
c) optionally adding at least one species of fermenting bacteria to the suspension, thereby fermenting the resulting suspension obtained in step b),
wherein enzymes in the at least one enzyme mixture are chosen from cellulases, cellobiases, amylases, lipases, pectinases, dextranses, oxidoreductases, proteases, pulpzymes and oxidases, and the natural polymeric materials are proteins, polysaccharides, polyphenols (lignins), fats, waxes, and mineral oils.

2. A method according to claim 1, wherein at least one species of fermenting bacteria is added to the suspension in step c), thereby fermenting the resulting suspension obtained in step b).

3. A method according to claim 1 or 2, characterised by that the enzymes in a first enzyme mixture are chosen from cellulases, cellobiases, amylases, lipases, pectinases, dextranses, oxidoreductases, pulpzymes and oxidases, and the enzymes in a second enzyme mixture are chosen from cellulases, cellobiases, amylases, lipases, pectinases, dextranses, oxidoreductases, proteases, pulpzymes and oxidases.

4. A method according to claim 1, characterised by that the enzyme mixture(s) comprise(s) a surfactant.

5. A method according to claim 4, characterised by that the surfactant is non-ionic.

6. A method according to claim 5, characterised by that the surfactant is chosen from natural and synthetic alcohol ethoxylates, FAE (fatty alcohol ethoxylate), non-ionic surface active agents prepared by the addition of ethylene oxide to propylene glycols, polydimethylsiloxane co-polymers and polyoxyethylene derivatives of fatty acid partial esters of hexitol anhydrides.

7. A method according to claim 6, characterised by that the surfactant is present in the range of 0.0025-5 w/w % of the sludge suspension, in particularly in the range of 0.0025-2 w/w %.

8. A method according to claim 1, characterised by that the dose of the enzyme mixture in relation to sludge suspension is 0.2-0.001% enzyme per 1% TS sludge.

9. A method according to 8, characterised by that the dose is 0.06-0.001% enzyme per 1% TS sludge.

10. A method according to claim 1, characterised by that the fermenting bacteria are chosen from acidogenic bacteria, acetogenic bacteria, and methane producing bacteria.

11. A method according to claim 10, characterised by that the fermenting bacteria are chosen from Gluconobacter oxydans, Acetobacter species, Acetogenium kivui, Bacillus macerans, polymyxa, Bacillus coagulans, Lactobacillus buchneri, Clostridium thermoaceticus, Clostridium lentocellum, Clostridium formicoaceticu, Clostridium thermocellum and Pseudomonas species.

12. A method according to claim 11, characterised by that at least one of the species of the fermenting bacteria is methane producing bacteria.

13. A method according to claim 12, characterised by that the methane producing bacteria are chosen from Methanosarcina barkeri, Methanosarcina mazeii, Methanosarcina soehngenii and Methanosarcina acetivorans, and Methanosaeta, and mixtures thereof.

14. A method according to claim 13, characterised by that the methane produced is separated from the sludge suspension.

15. A method according to claim 1, characterised by that the temperature of the sludge suspension is from 20° C. to 90° C.

16. A method according to claim 1, characterised by that the sludge suspension is subjected to agitation in the range from 0 to 180 rpm.

17. A method according to claim 1, characterised by that the sludge is pre-concentrated, prior to the addition of enzymes and bacteria, by gravitation or enhanced sedimentation to the range 10-300 g sludge solids per 1 l sludge suspension.

18. A method according to claim 1, characterised by that the sludge suspension is subjected to a pre-treatment chosen from the group comprising acid treatment, base treatment, sonication, grinding and heating.

19. Use of a method according to claim 1, in addition to conventional digestion used in water purification.

20. Use of a method according to claim 1, instead of conventional digestion used in water purification.
